(19) United States
(12) Patent Application Publication
(10) Pub. No.: US 2007/0147683 A1
(43) Pub. Date: Jun. 28, 2007

(54) Method, medium, and system recognizing a face, and method, medium, and system extracting features from a facial image

(75) Inventors: Won-jun Hwang, Yongin-si (KR); Gyu-tae Park, Yongin-si (KR); Haitao Wang, Yongin-si (KR); Seok-cheol Kee, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/642,883

(22) Filed: Dec. 21, 2006

(30) Foreign Application Priority Data
Dec. 23, 2005 (KR) 10-2005-0128742

(51) Int. Cl. G06K 9/46; G06K 9/66

(52) U.S. Cl. 382/190

(57) ABSTRACT

Methods, mediums and systems recognizing a face by extracting features from a facial image. According to the method recognizing the face, multiple subimages of a query facial image and one or more target facial images are generated, Fourier transforms on the multiple subimages are performed, and Fourier features from the multiple subimages are extracted using the Fourier-transformed multiple subimages. A similarity between the Fourier features of the query facial image and the one or more target facial images is measured, and similarities with respect to a plurality of target facial images are calculated. An image having a maximum similarity to the query facial image from the one or more target facial images is selected.

### CROSS-REFERENCE TO RELATED APPLICATIONS

This application claims the benefit of Korean Patent Application No. 10-2005-0128742, filed on Dec. 23, 2005, in the Korean Intellectual Property Office, the disclosure of which is incorporated herein in its entirety by reference.

### BACKGROUND

1. Field

One or more embodiments of the present invention relates to a method, medium, and system recognizing a face, and a method, medium and system extracting features from a facial image.

2. Description of the Related Art

Automated face recognition systems identify a person by comparing a facial image input through a camera with templates.

Face recognition techniques generally fall into two categories. The first category includes obtaining a feature value of each element of a face and compares mutual correlation, e.g. compares a nose length or a nose to eye distance between two images. The second category includes comparing the most important image data of a face, such as the nose's size, with facial data stored in a database to find matches.

Since a facial image is produced by projecting a 3-dimensional face onto a 2-dimensional plane, the projected 2-dimensional facial image lacks information important for recognition, such as a depth, size, and rotation, for example. Basically, the complexity of a face pattern and the complexity of the environment, such as lighting conditions and background, make face recognition difficult. Also, a variety of factors such as wearing glasses, partial overlap, and variation of facial expressions may make face recognition difficult.

Since a face is not a rigid object having a constant shape, it is more difficult to recognize a person from their facial image. There are millions of face types having different shapes, and even the same face may change shape over time. Faces are further different depending on race, gender, and the individual, and the individual face changes depending on expression, age, head shape, and whether cosmetics are worn.

Therefore, when a mathematical face model uses images of a constant face size, it is difficult to obtain global features for the face, and, thus, difficult to identify a person with facial images having various transformed images.

### SUMMARY

One or more embodiments of the present invention provide a method, medium, and system recognizing a face by analyzing facial feature information in a Fourier domain with respect to facial images having the same size and different eye distances.

One or more embodiments of the present invention also provide a method, medium, and system extracting features in a Fourier domain from a facial image.

One or more embodiments of the present invention also provide a method, medium and system recognizing a face using a face model employing facial images having the same size and different eye distances.

Additional aspects and/or advantages of the invention will be set forth in part in the description which follows and, in part, will be apparent from the description, or may be learned by practice of the invention.

According to an aspect of the present invention, there is provided a method of recognizing a face, the method including: generating multiple subimages of a query facial image and a one or more target facial images; performing Fourier transforms on the multiple subimages and extracting Fourier features from the multiple subimages using the Fourier-transformed multiple subimages; measuring a similarity between the Fourier features of the query facial image and the one or more target facial images; and selecting an image having a maximum similarity to the query facial image from the one or more target facial images.

According to another aspect of the present invention, there is provided a system for recognizing a face, the system including: a multi-subimage generating unit to generate multiple subimages of a query facial image and one or more target facial images; a Fourier feature extracting unit to perform Fourier transforms on the multiple subimages and to extract Fourier features using the Fourier-transformed multiple subimages; and a recognition unit to measure a similarity between the Fourier features of the query facial image and the one or more target facial images, and to select an image having a maximum similarity to the query facial image from the one or more target facial images.

According to another aspect of the present invention, there is provided a method of extracting a feature from a facial image, the method including: performing a Fourier transform on an input image; classifying the Fourier-transformed input image into a plurality of Fourier domains; classifying each Fourier domain into one of a plurality of frequency bands that reflect corresponding features of the Fourier domain; extracting features for each of the classified frequency band; and concatenating the extracted features for each Fourier domain and concatenating the concatenated, extracted features to output as features of the input image.

According to another aspect of the present invention, there is provided a feature extracting system including: a Fourier transforming portion to perform a Fourier transform on an input image; a Fourier domain classifier to classify the Fourier-transformed input image into a plurality of Fourier domains; a frequency band classifier to classify each Fourier domain into one of a plurality of frequency bands that reflect corresponding features of the Fourier domain; a feature extracting portion to extract features using a Fourier component corresponding to each of the classified frequency bands; and a feature concatenating portion to concatenate all of the extracted features for each Fourier domain and to concatenate the concatenated, extracted features as a whole to generate the Fourier features.

According to another aspect of the present invention, there is provided a method of recognizing a face, the method including: generating multiple subimages of a query facial image and one or more target facial images; extracting features of the multiple subimages; measuring a similarity between features of the query facial image and the one or more target facial images using the features of the multiple subimages; and selecting a facial image having a maximum similarity to the query facial image from the one or more target facial images.

According to another aspect of the present invention, there is provided an apparatus for recognizing a face, the apparatus including: a multi-subimage generating unit to generate multiple subimages of a query facial image and one or more target facial images; a feature extracting unit to extract features of the multiple subimages; and a recognition unit to measure a similarity between features of the query facial image and the one or more target facial images using the features of the multiple subimages, calculate similarities with respect to the one or more target images, and and select a facial image having a maximum similarity to the query facial image from the one or more target facial images.

According to another aspect of the present invention, there is provided at least one medium comprising computer readable code to control at least one processing element to implement any one of the methods.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a system extracting a Fourier feature from a facial image, according to an embodiment of the present invention;

FIG. 2 illustrates a method of extracting a Fourier feature from a facial image, according to an embodiment of the present invention;

FIG. 3 shows a plurality of exemplified classes distributed in a Fourier domain;

FIG. 4A shows a low frequency band;

FIG. 4B shows an intermediate frequency band;

FIG. 4C shows an entire frequency band including a high frequency band;

FIG. 5 illustrates a system recognizing a face using a multi-face model, according to an embodiment of the present invention;

FIG. 6 illustrates a method of recognizing a face using a multi-facial model, according to an embodiment of the present invention;

FIGS. 7A through 7D illustrate a process of generating subimages having different eye distances from an input image, according to an embodiment of the present invention;

FIG. 8 illustrates a system recognizing a face, according to an embodiment of the present invention;

FIG. 9 illustrates a method of recognizing a face, according to an embodiment of the present invention; and

FIG. 10 shows examples of facial images used for a face recognition experiment.

### DETAILED DESCRIPTION OF EMBODIMENTS

Reference will now be made in detail to one or more embodiments of the present invention, examples of which are illustrated in the accompanying drawings, wherein like reference numerals refer to the like elements throughout. The one or more embodiments are described below to explain the present invention by referring to the figures.

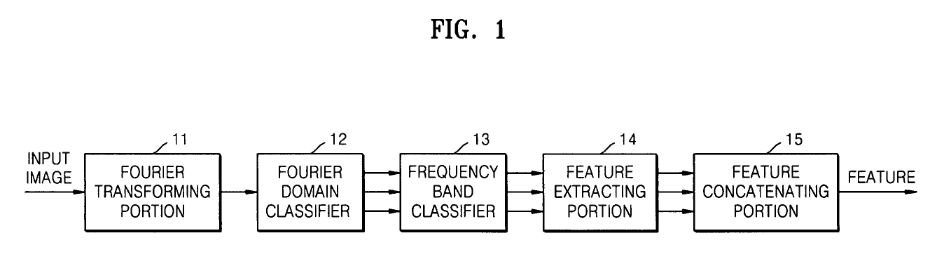

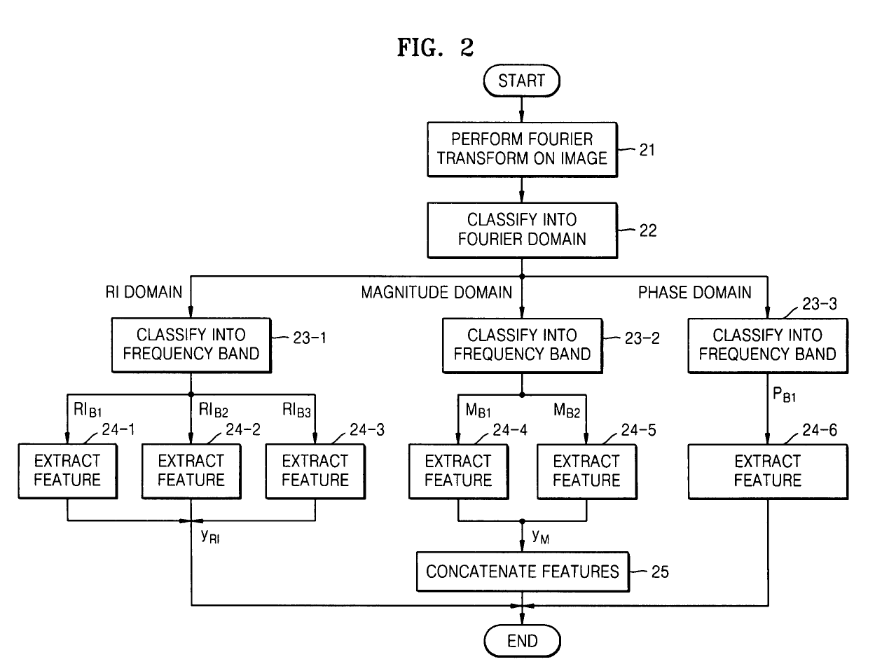

FIG. 1 illustrates a system extracting Fourier features from a facial image, according to an embodiment of the present invention. The system may include a Fourier transforming portion 11, a Fourier domain classifier 12, a frequency band classifier 13, a feature extracting portion 14, and a feature concatenating portion 15, for example. The operation of each element will be described with reference to the flowchart of FIG. 2, noting that the described system and method are mutually exclusive, and should not be limited to the same.

The Fourier transforming portion 11 may perform a Fourier transform on an input image using Equation 1 below, as an example (operation 21).

$$Equation 1 \text{:} \\ F ( u , v ) = \frac{1}{MN} {\sum }_{x = 0}^{M - 1} {\sum }_{y = 0}^{N - 1} χ ( x , y ) exp [ - j2π ( \frac{ux}{M} + \frac{vy}{N} ) ] \\ 0 \leq u \leq ( M - 1 ) , 0 \leq v \leq ( N - 1 )$$

Here, M is the number of pixels in an x-axis direction of an image, and N is the number of pixels in a y-axis direction of an image, and X(x,y) is a piexel value of an input image.

The Fourier domain classifier 12 may classify the Fourier-transformed results, e.g., according to Equation 1, into a plurality of domains (operation 22). The Fourier domains correspond to components classified into a real component R(u,v)/imaginary component I(u,v), a magnitude component |F(u,v)|, and a phase component φ(u,v) of the Fourier-transformed results expressed by Equation 2 below, as an example.

$$Equation 2 \text{:} \\ F ( u , v ) = R ( u , v ) + jI ( u , v ) \\ \vert F ( u , v ) \vert = {[ {R}^{2} ( u , v ) + {I}^{2} ( u , v ) ]}^{1 / 2} \\ ϕ ( u , v ) = {tan}^{- 1} [ \frac{I ( u , v )}{R ( u , v )} ]$$

Since it is difficult to determine which class a facial image belongs to merely by considering any one of the Fourier domains illustrated in FIG. 3, it is desirable to classify an image for each Fourier domain. Here, the class may be a single space in Fourier domains occupied by a plurality of facial images of one person.

For example, referring to FIG. 3, it is difficult to discriminate class 1 from class 3 in terms of phase but easy to discriminate them from each other in terms of magnitude. Also, it is difficult to discriminate class 1 from class 2 in terms of magnitude but easy to discriminate them from each other in terms of phase. In FIG. 3, x1, x2, and x3 are examples of features included in class 1, class 2 and class 3, respectively. FIG. 3 further demonstrates that classification reflecting the Fourier domains is advantageous to face recognition.

In general template-based face recognition, the magnitude, i.e., a Fourier spectrum, is mainly used to describe a facial feature. Phase change is less commonly used because phase changes drastically while the magnitude changes smoothly for a relatively small spatial displacement. In the present embodiment, a phase domain showing conspicuous features in a facial image, especially a phase domain in a low frequency band, which is relatively less sensitive, is considered together with the magnitude domain. Also, face recognition is performed in the present embodiment using a total of three Fourier feature domains in order to reflect all, or a majority of, the details of a face. The Fourier feature domains include a real/imaginary domain (referred to as an RI domain), a magnitude domain, and a phase domain. Generally, the Fourier feature domains will include different features within each frequency band depending on the particular features of a given facial image. Therefore, it may be advantageous to classify all of the Fourier feature domains into a plurality of frequency bands.

Accordingly, the frequency band classifier 13 may classify each Fourier domain into a plurality of frequency bands (operation 23). According to an embodiment, the frequency band is classified into a low frequency band B1 that corresponds to 0-⅓ of the entire band, a frequency band below an intermediate frequency B2 that corresponds to 0-⅔ of the entire band, and a frequency band B3 that corresponds to the entire band, although additional and different frequency band classifications may be added or substituted for those above.

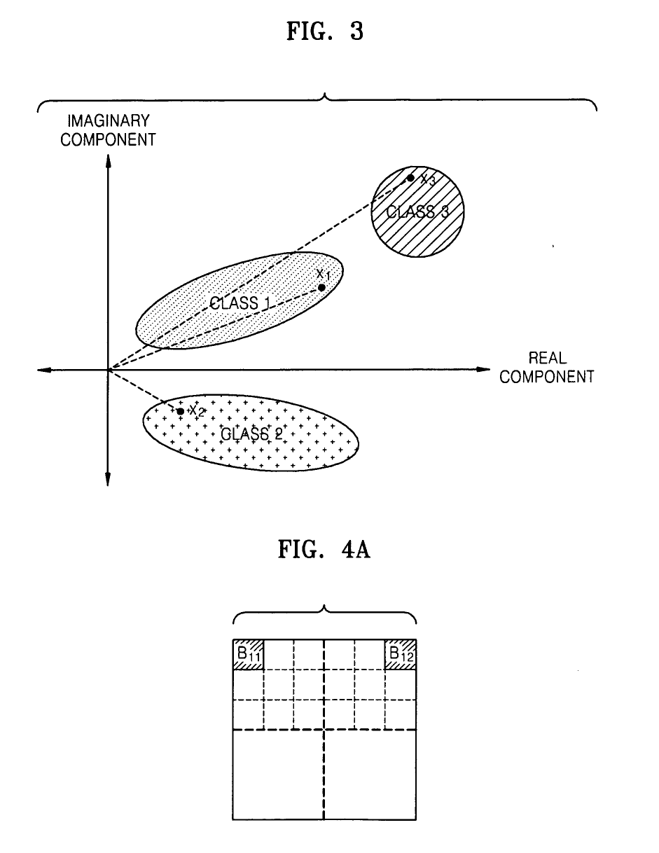

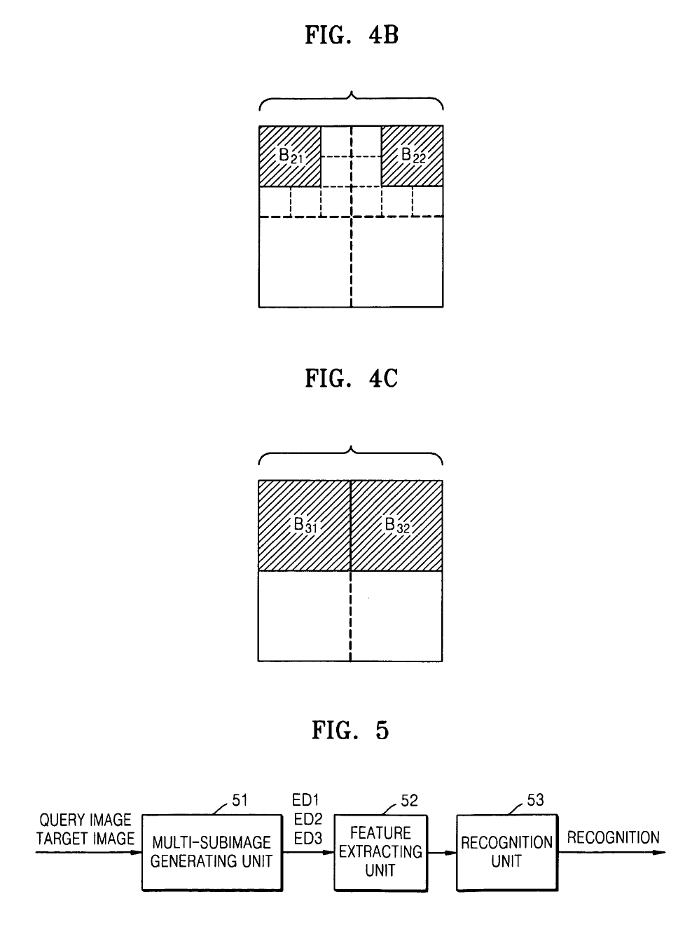

In a facial image, the low frequency band is located at the outer side of the Fourier domain, and the high frequency band is located at the central portion of the Fourier domain. Thus, according to this embodiment, FIG. 4A shows the low frequency band B1 (B11 and B12) classified according to the present embodiment, FIG. 4B shows the frequency band below the intermediate frequency B2 (B21 and B22), and FIG. 4C shows the entire frequency band B3 (B31 and B32) including the high frequency band.

In the RI domain of the Fourier transformed results, Fourier components in the frequency bands B1, B2, and B3 are all considered (operation 23-1). Since the magnitude domain does not contain sufficient information in the high frequency band, the magnitude domain may consider components in the frequency bands B1 and B2 but not B3 (operation 23-2). The phase domain may consider only a component in the frequency band B1 but not B2 and B3, where the phase changes drastically (operation 23-3). Since the phase changes drastically with respect to small variations in the intermediate and high frequency bands, it is proper to consider only the low frequency band.

The feature extracting portion 14 extracts features from Fourier components in the frequency bands classified from each of the Fourier domains. In one embodiment, feature extraction is performed using Principal Component and Linear Discriminant Analysis (PCLDA) method, although other feature extraction methods may be used.

Linear Discriminant Analysis (LDA) is a method of training to project data linearly onto a sub-space that maximizes a between-class scatter while reducing a within-class scatter. For this purpose, a between-class scatter matrix S_{B} representing a between-class variance, and a within-class scatter matrix Sw representing a within-class variance may be defined by Equation 3 below.

$$Equation 3 \text{:} \\ {S}_{B} = {\sum }_{i = 0}^{c} {M}_{i} ( {m}_{i} - m ) {( {m}_{i} - m )}^{T} \\ {S}_{W} = {\sum }_{i = 0}^{c} {\sum }_{{ϕ}_{k} ∈ {c}_{i}} ( {ϕ}_{k} - {m}_{i} ) {( {ϕ}_{k} - {m}_{i} )}^{T}$$

Here, mᵢ is an average image of I-th class cᵢ having Mi samples, and c is the number of classes. A transform matrix Wopt is obtained to satisfy Equation 4 below, as an example.

$$\begin{matrix}Equation 4 \text{:} & \\ {W}_{opt} = {}^{arg} {max}_{w} \frac{{W}^{T} {S}_{B} W}{{W}^{T} {S}_{w} W} = [ {w}_{1} , {w}_{2} , … , {w}_{n} ] & Equation 4\end{matrix}$$

Here, n is the number of projection vectors, and n=min (c-1, N, M).

Principal Component Analysis (PCA) may be performed before the LDA is performed to reduce the dimensionality of the vectors and overcome singularity of the within-class scatter matrix. This process is referred to as PCLDA in an embodiment. The performance of PCLDA depends on the number of eigenspaces used in reducing input dimension.

Thus, in such an embodiment, the feature extracting portion 14 may extract features for a corresponding frequency band of each Fourier domain using the PCLDA (operations 24-1, 24-2, 24-3, 244, 24-5, and 24-6). For example, a feature Y_{RIB1} in B1 of the RI domain may be given by Equation 5 below.
y_{RIB1}=W^{T}_{RBI1}(RI_{B1}−m_{RIB1}) Equation 5

Here, W_{RIB1} is a transform matrix of PCLDA trained to output features of a Fourier component of RI_{B1} according to Equation 4 in a training set, and m_{RIB1} is an average of the features in RI_{B1}.

The feature concatenating portion 15 concatenates features output from the feature extracting portion 14 (operation 25). Features output from three frequency bands of the RI domain, features output from two frequency bands of the magnitude domain, and features output from one frequency band of the phase domain may be concatenated through Equation 6 below, for example.
y_{RI}=[y_{RIB1}y_{RIB2}y_{RIB3}]
y_{M}=[y_{MB1}y_{MB2}]
y_{P}=[y_{PB1}] Equation 6

Features of Equation 6 may eventually be concatenated again using ‘f’ shown in Equation 7 below to form a complementary feature, for example.
f=[y_{RI}y_{M}y_{P}] Equation 7

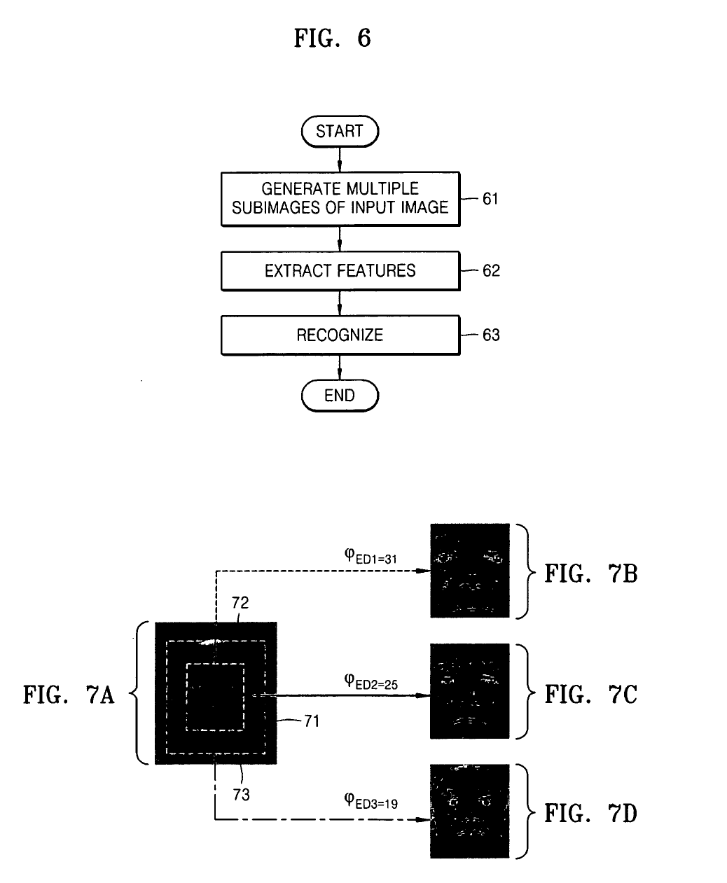

FIG. 5 illustrates a system for recognizing a face using a multi-facial model, according to an embodiment of the present invention. The system may include a multi-subimage generating unit 51, a feature extracting unit 52, and a recognition unit 53, for example. An operation of the system will now be described with reference to the flowchart of FIG. 6, which illustrates a method of recognizing a face using a multi-face model, according to an embodiment of the present invention, noting that alternative implementations of each of the system and method are equally available.

The multi-subimage generating unit 51 generates subimages having different eye distances with respect to both: an input query image, which is a facial image of a subject to be identified and; a target image, which is one of a plurality of facial images pre-stored in a database (not shown) (operation 61).

Here, in this example, the subimages all have the same size of 46×56 and different eye distances.

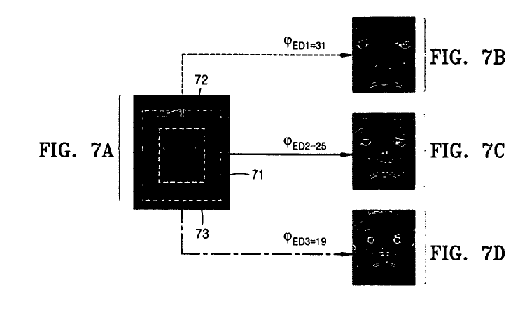

FIGS. 7A through 7D illustrate a process of creating subimages having different eye distances from an input image.

FIG. 7A illustrates an example of an input image, with reference numeral 71 representing only the features of the face's inner portion, completely excluding the head and the background, reference numeral 73 representing the overall shape of the face, and reference numeral 72 representing an intermediate image between the images represented by the reference numerals 71 and 73.

FIGS. 7B through 7D illustrate images each having, as an example, a size of 46×56, produced after a pre-process such as a lighting process has been performed on the images represented by the reference numerals 71 through 73. Here, the coordinates of the left and right eyes of the three illustrated images are [(7, 20) (38, 20)], [(10, 21) (35, 21)], [(13, 22) (32, 22)], respectively.

An image ED1 illustrated in FIG. 7B contains a pose, namely, a face direction. If there are changes in elements such as a nose shape change or a wrong eye coordinate, the training performance will likely be drastically reduced.

An image ED3 illustrated in FIG. 7D includes the overall shape of the face and thus is robust to pose changes or erroneous eye coordinates. Also, since a subject's hairstyle does not usually change over a short time, the image ED3 should show excellent performance. However, when the subject's hairstyle changes, as an example, the training performance may be reduced. In addition, because the image ED3 has a relatively small amount of information regarding the inner facial region, this inner face information may not be sufficiently reflected in training, and thus the overall performance may be lowered.

An image ED2 illustrated in FIG. 7C may include advantages of FIGS. 7B and 7D. It does not contain excessive head information or background information, and mainly contains information regarding the face's inner elements, and accordingly may show the most stable performance of the three images.

The feature extracting portion 15 extracts features from the images ED1, ED2, and ED3 illustrated in FIGS. 7B through 7D, respectively (operation 62). Any conventional method may be used to extract the features. In the present embodiment, the features are extracted using the PCLDA as described above, as only an example.

The recognition unit 53 compares the similarities between features extracted from the query image and the one or more target images, to recognize the person that corresponds to the target image having maximum similarity to the query image (operation 63).

The similarity may be calculated by comparing a feature Fᵢ finally extracted from the query image i with a feature Fⱼ finally extracted from a current target image j using Equation 8, as an example, below.

$$Equation 8 \text{:} \\ {F}_{i} = [ {f}_{{i}_{1}} , {f}_{{i}_{2}} , {f}_{{i}_{3}} ] , {F}_{j} = [ {f}_{{j}_{1}} , {f}_{{j}_{2}} , {f}_{{j}_{3}} ] \\ S ( {F}_{i} , {F}_{j} ) = {\sum }_{k = 1}^{3} {w}_{k} \cdot ( \frac{{f}_{{i}_{k}} \cdot {f}_{{j}_{k}}}{‖ {f}_{{i}_{k}} ‖ \cdot ‖ {f}_{{j}_{k}} ‖} ) , {\sum }_{k = 1}^{3} {w}_{k} = 1$$

Here, fᵢₖ is a feature of a k-th subimage associated with the query image i.

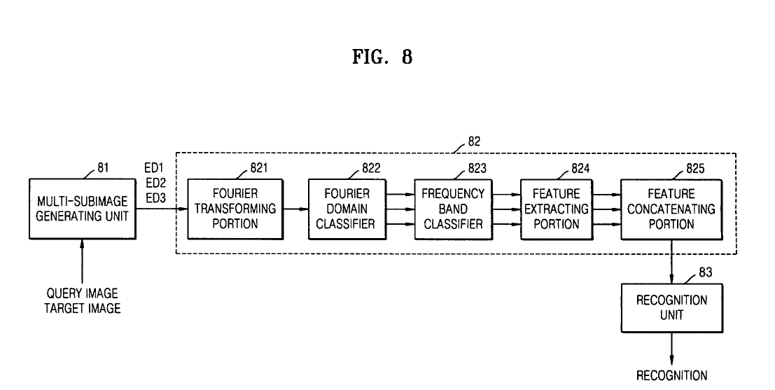

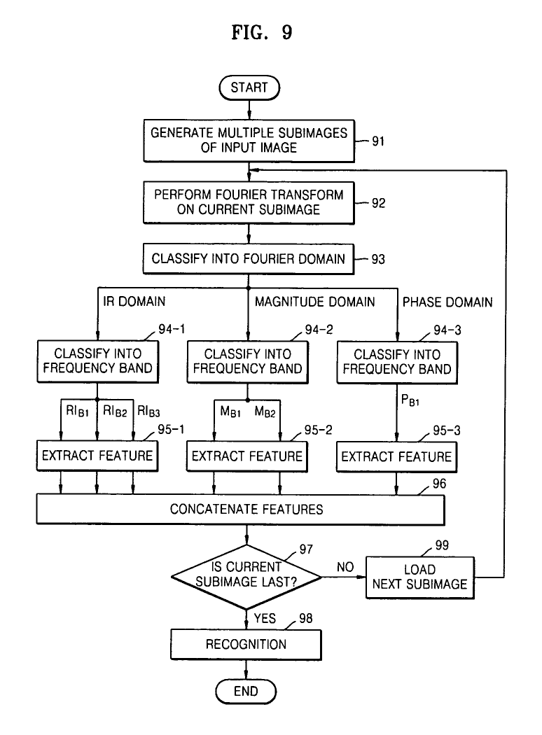

FIG. 8 illustrates a system for recognizing a face, according to an embodiment of the present invention, and FIG. 9 is a flowchart of a method of recognizing a face, according to an embodiment of the present invention.

The apparatus illustrated in FIG. 8 may include a multi-subimage generating unit 81, a Fourier feature extracting unit 82, and a recognition unit 83, for example. The Fourier feature extracting unit 82 may further include a Fourier transforming portion 821, a Fourier domain classifier 822, a frequency band classifier 823, a feature extracting portion 824, and a feature concatenating portion 825, for example. The operation of the apparatus will be described with reference to FIG. 9, again noting that alternative implementations of each the system and method are equally available.

The multi-subimage generating unit 81 generates a plurality of subimages ED1 through ED3 with respect to an input image, namely, a query image and one or more target images (operation 91). The subimages may be generated as illustrated in FIGS. 7A through 7D. The multi-subimage generating unit 81 may generate additional subimages than the exemplary images described above, or different subimages may be substituted, or both.

The Fourier transforming portion 821 performs a Fourier transform on a current subimage (operation 92). The Fourier domain classifier 822 classifies the Fourier-transform results into each Fourier domain, namely for an RI domain, a magnitude domain, and a phase domain (operation 93), as an example.

The frequency band classifier 823 classifies each Fourier domain into frequency bands. As described above, the RI domain is classified into frequency bands B1, B2, and B3 (operation 94-1), the magnitude domain is classified into frequency bands B1 and B2 only (operation 94-2), and the phase domain is classified into a frequency band B1 (operation 94-3), although different frequency bands may be chosen for each of the Fourier domains.

The feature extracting portion 824 extracts features according to a corresponding frequency band in each Fourier domain (operations 95-1, 95-2, and 95-3). As described above, one or more embodiments of the present invention may extract the features using PCLDA. The feature concatenating portion 825 may concatenate the features extracted according to the corresponding frequency band in each Fourier domain using Equations 6 and 7 (operation 96), as an example.

When the current subimage is the last subimage of the input image in an operation 97, the recognition unit 83 may compare the similarities between the Fourier features extracted for the query and one or more target images, and recognize a person that corresponds to the target image having the maximum similarity to the query image (operation 98). The similarity is calculated using Equation 8, as an example.

When the current subimage is not the last subimage in the operation 97, a next subimage is loaded and then the operations 92 through 98 may be repeated (operation 99).

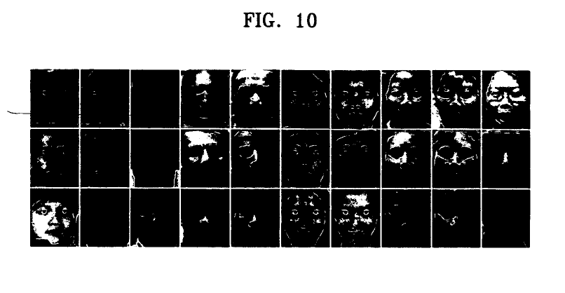

FIG. 10 shows examples of facial images used for a face recognition experiment according to the present invention and conventional techniques. Here,the illustrated facial images have been extracted from a Face Recognition Grand Test Database for exemplary purposes.

The illustrated facial images include controlled images having uniform contrast, photographed under uniform lighting, and uncontrolled images having non-uniform contrast, photographed under non-uniform lighting.

In an experiment of an embodiment of the present invention, a training set contained 12,776 facial images for 222 persons, and a test set contained 6,067 facial images for 466 persons. Each of the facial images in the test set was obtained by averaging test results after performing a total of 4 tests.

Thus, experiments were performed using a first experimental group and a second experimental group. In the first experimental group, the controlled images were registered and then recognition on the controlled images was performed. On the other hand, in the second experimental group, the controlled images were registered and then recognition on the uncontrolled images was performed.

The below Table 1 shows experiment results for the first and second experimental groups. In Table 1, PCA (ED2) shows the results obtained when the PCA algorithm is applied to the ED 2 image, and LDA (ED2) shows the results obtained when the LDA algorithm is applied to the ED2 image.

Also, in Table 1, ED1, ED2, and ED3 show the results obtained by performing recognition using features extracted according to one or more methods of extracting Fourier features of the present invention.

Here, ED1+ED2+ED3 shows the results obtained by a method of recognizing a face by extracting features of all images ED1, ED2, and ED3 according to one or more methods of extracting Fourier features and concatenating the extracted features, according to one or more embodiments of the present invention.

TABLE 1

| | First | | Second | |
|---|---|---|---|---|
| | experimental group | | experimental group | |
| | | VR | | VR |
| | EER | (FAR = 0.1%) | EER | (FAR = 0.1%) |
| PCA(ED2) | 4.48% | 78.86% | 22.16% | 16.08% |
| LDA(ED2) | 2.1% | 88.69% | 5.45% | 56.74% |
| ED1 | 1.89% | 91.77% | 5.06% | 66.98% |
| ED2 | 1.51% | 92.95% | 4.39% | 69.88% |
| ED3 | 1.96% | 88.71% | 4.96% | 63.05% |
| ED1 + ED2 + ED3 | 1.31% | 94.27% | 3.50% | 75.59% |

Here, FAR (false acceptance rate) indicates a rate that a stranger is accepted as an authorized person, and FRR (false rejection rate) indicates a rate that an authorized person is rejected as a stranger. Also, an EER (equal error rate) is a false recognition rate when FAR=FRR, and id referred when considering the overall performance.

VR is the verification ratio of verifying an authorized person. When VR=100%-FRR, VR adopted in one or more embodiments of the present invention represents a value satisfying FAR=0.1%.

According to Table 1, when face recognition is performed after extracting features in accordance with a one or more methods of extracting Fourier features, in accordance with embodiments of the present invention, ED1, ED2, and ED3 each gives a higher VR and a lower EER than the conventional PCA or LDA method.

Also, when Fourier features are extracted from all of ED1, ED2, and ED3, and face recognition is performed by concatenating the extracted features, the VR and EER are better than any other cases.

According to one or more embodiments of the present invention, the Fourier domain may be classified into three domains including the real/imaginary domain, the magnitude domain, and the phase domain, so that the various domains may be used to express a Fourier feature space. Also, only the frequency bands that correspond to the feature of a corresponding domain are classified and features are extracted from the classified frequency bands to reduce the calculation complexity.

Recognition performance robust to a face pose and information of a face shape can be achieved by adopting and training the multi-face model using information regarding the inner portion of a face and information regarding the outline of the face, obtained respectively from subimages ED1 and ED3 of FIG. 7B and FIG. 7D, respectively.

In addition to this discussion, embodiments of the present invention can also be implemented through computer readable code/instructions in/on a medium, e.g., a computer readable medium, to control at least one processing element to implement any above described embodiment. The medium can correspond to any medium/media permitting the storing and/or transmission of the computer readable code.

The computer readable code can be recorded/transferred on a medium in a variety of ways, with examples of the medium including magnetic storage media (e.g., ROM, floppy disks, hard disks, etc.), optical recording media (e.g., CD-ROMs, or DVDs), and storage/transmission media such as carrier waves, as well as through the Internet, for example. Here, the medium may further be a signal, such as a resultant signal or bitstream, according to embodiments of the present invention. The media may also be a distributed network, so that the computer readable code is stored/transferred and executed in a distributed fashion. Still further, as only a example, the processing element could include a processor or a computer processor, and processing elements may be distributed and/or included in a single device.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of recognizing a face, the method comprising:
generating multiple subimages of a query facial image and one or more target facial images;
performing Fourier transforms on the multiple subimages and extracting Fourier features from the multiple subimages using the Fourier-transformed multiple subimages;
measuring a similarity between the Fourier features of the query facial image and the one or more target facial images; and
selecting an image having a maximum similarity to the query facial image from the one or more target facial images.

2. The method as claimed in claim 1, wherein the multiple subimages are a plurality of images having a same size and different eye distances for a same facial image.

3. The method as claimed in claim 1, wherein the extracting of the Fourier features comprises:
performing the Fourier transforms on the multiple subimages;
classifying the Fourier-transformed multiple subimages into a plurality of Fourier domains;
extracting features for each classified Fourier domain using a corresponding Fourier component; and
concatenating all of the extracted features for each classified Fourier domain to generate the extracted Fourier features.

4. The method as claimed in claim 3, wherein the classifying the Fourier-transformed multiple subimages comprises classifying each of the Fourier domains into a plurality of frequency bands corresponding to the extracted features of each of the Fourier domains, and the extracting of the features comprises extracting the features using a Fourier component that corresponds to the classified frequency band.

5. The method as claimed in claim 4, wherein the extracted features are extracted by subtracting an average Fourier component of a corresponding frequency band from the Fourier component of the corresponding frequency band, and multiplying the subtracted average Fourier component by a pre-trained transform matrix.

6. The method as claimed in claim 5, wherein the pre-trained transform matrix is trained to output the features when a Fourier component is input according to a PCLDA (Principal Component and Linear Discriminant Analysis) algorithm.

7. The method as claimed in claim 3, wherein the Fourier domain comprises an RI (real/imaginary) domain, a magnitude domain, and a phase domain of the Fourier-transformed multiple subimages.

8. The method as claimed in claim 7, wherein when an entire frequency band is divided into three equal bands, the RI domain consists of a low frequency band, a frequency band below an intermediate frequency, and an entire frequency band, the magnitude domain consists of the low frequency band and the frequency band below the intermediate frequency, and the phase domain consists of the low frequency band.

9. The method as claimed in claim 1, wherein the similarity is defined by the Equation below;
$${F}_{i} = [ {f}_{{i}_{1}} , {f}_{{i}_{2}} , {f}_{{i}_{3}} ] , {F}_{j} = [ {f}_{{j}_{1}} , {f}_{{j}_{2}} , {f}_{{j}_{3}} ]$$
$$S ( {F}_{i} , {F}_{j} ) = {\sum }_{k = 1}^{3} {w}_{k} \cdot ( \frac{{f}_{{i}_{k}} \cdot {f}_{{j}_{k}}}{‖ {f}_{{i}_{k}} ‖ \cdot ‖ {f}_{{j}_{k}} ‖} ) , {\sum }_{k = 1}^{3} {w}_{k} = 1$$
where Fᵢ is a Fourier feature for the query facial image i, Fⱼ is a Fourier feature for the target facial image j, fᵢₖ is a feature of a k-th subimage of the query facial image i, and fⱼₖ is a feature of a k-th subimage of the target facial image j.

10. A system for recognizing a face, the system comprising:
a multi-subimage generating unit to generate multiple subimages of a query facial image and one or more target facial images;
a Fourier feature extracting unit to perform Fourier transforms on the multiple subimages and to extract Fourier features using the Fourier-transformed multiple subimages; and
a recognition unit to measure a similarity between the Fourier features of the query facial image and the one or more target facial images, and to select an image having a maximum similarity to the query facial image from the one or more target facial images.

11. The system as claimed in claim 10, wherein the multi-subimage generating unit generates a plurality of subimages having a same size and different eye distances for a same facial image.

12. The system as claimed in claim 10, wherein the Fourier feature extracting unit comprises:
a Fourier transforming portion arranged to perform Fourier transforms on the multiple subimages;
a Fourier domain classifier arranged to classify the Fourier-transformed multiple subimages into a plurality of Fourier domains;
a feature extracting portion arranged to extract features using a Fourier component corresponding to each Fourier domain; and
a feature concatenating portion arranged to concatenate all of the extracted features for each classified Fourier domain to generate the extracted Fourier features.

13. The system as claimed in claim 12, wherein the Fourier domain classifier classifies the Fourier-transformed multiple subimages into an RI domain, a magnitude domain, and a phase domain.

14. The system as claimed in claim 13, further comprising:
a frequency band classifier, between the Fourier domain classifier and the feature extracting portion, to classify each of the Fourier domains into a plurality of frequency bands corresponding to the extracted features of each of the Fourier domains,
wherein the feature extracting portion extracts the features using a Fourier component corresponding to the classified frequency band.

15. The system as claimed in claim 14, wherein the frequency band classifier divides an entire frequency band into three equal bands, the RI domain consists of a low frequency band, a frequency band below an intermediate frequency, and an entire frequency band, the magnitude domain consists of the low frequency band and the frequency band below the intermediate frequency, and the phase domain consists of the low frequency band.

16. The system as claimed in claim 10, wherein the recognition unit calculates the similarity using the Equation below:
$${F}_{i} = [ {f}_{{i}_{1}} , {f}_{{i}_{2}} , {f}_{{i}_{3}} ] , {F}_{j} = [ {f}_{{j}_{1}} , {f}_{{j}_{2}} , {f}_{{j}_{3}} ]$$
$$S ( {F}_{i} , {F}_{j} ) = {\sum }_{k = 1}^{3} {w}_{k} \cdot ( \frac{{f}_{{i}_{k}} \cdot {f}_{{j}_{k}}}{‖ {f}_{{i}_{k}} ‖ \cdot ‖ {f}_{{j}_{k}} ‖} ) , {\sum }_{k = 1}^{3} {w}_{k} = 1$$
where Fᵢ is a Fourier feature for the query facial image i, Fj is a Fourier feature for the target facial image j, fᵢₖ is a feature of a k-th subimage of the query facial image i, and fⱼₖ is a feature of a k-th subimage of the target facial image j.

17. A method of extracting a feature from a facial image, the method comprising:
performing a Fourier transform on an input image;
classifying Fourier-transformed input image into a plurality of Fourier domains;
classifying each Fourier domain into one of a plurality of frequency bands that reflect corresponding features of the Fourier domain;
extracting features for each of the classified frequency bands; and
concatenating the extracted features for each Fourier domain and concatenating the concatenated, extracted features to output as features of the input image.

18. The method as claimed in claim 17, wherein the extracted features are extracted by subtracting an average Fourier component of a corresponding frequency band from a Fourier component of the corresponding frequency band, and multiplying the subtracted average Fourier component by a pre-trained transform matrix.

19. The method as claimed in claim 18, wherein the pre-trained transform matrix is trained to output the extracted features when the Fourier component is input according to a PCLDA algorithm.

20. The method as claimed in claim 17, wherein each of the plurality of Fourier domains comprises an RI (real/imaginary) domain, a magnitude domain, and a phase domain of the Fourier-transformed multiple subimages.

21. The method as claimed in claim 20, wherein when an entire frequency band is divided into three equal bands, the RI domain consists of all of a low frequency band, a frequency band below an intermediate frequency band, and an entire frequency band, the magnitude domain consists of the low frequency band and the frequency band below the intermediate frequency, and the phase domain consists of the low frequency band.

22. A facial feature extracting system comprising:
a Fourier transforming portion to perform a Fourier transform on an input image;
a Fourier domain classifier to classify Fourier-transformed input image into a plurality of Fourier domains;
a frequency band classifier to classify each Fourier domain into one of a plurality of frequency bands that reflect corresponding features of the Fourier domain;
a feature extracting portion to extract features using a Fourier component corresponding to each of the classified frequency bands; and
a feature concatenating portion to concatenate the extracted features for each Fourier domain and to concatenate the concatenated, extracted features as a whole to output as features of the input image.

23. The feature extracting system as claimed in claim 22, wherein the Fourier domain classifier classifies the Fourier-transformed input image into an RI domain, a magnitude domain, and a phase domain.

24. The feature extraction system as claimed in claim 23, wherein the frequency band classifier classifies such that when an entire frequency band is divided into three equal bands, the RI domain consists of all of a low frequency band, a frequency band below an intermediate frequency, and an entire frequency band, the magnitude domain consists of the low frequency band and the frequency band below the intermediate frequency, and the phase domain consists of only the low frequency band.

25. A method of recognizing a face, the method comprising:
generating multiple subimages of a query facial image and of one or more target facial images;
extracting features of the multiple subimages;
measuring a similarity between features of the query facial image and the one or more target facial images using the features of the multiple subimages; and
selecting a facial image having a maximum similarity to the query facial image from the one or more target facial images.

26. The method as claimed in claim 25, wherein the multiple subimages are a plurality of images having a same size and different eye distances for a same facial image.

27. The method as claimed in claim 25, wherein the similarity is given by the Equation below;
$${F}_{i} = [ {f}_{{i}_{1}} , {f}_{{i}_{2}} , {f}_{{i}_{3}} ] , {F}_{j} = [ {f}_{{j}_{1}} , {f}_{{j}_{2}} , {f}_{{j}_{3}} ]$$
$$S ( {F}_{i} , {F}_{j} ) = {\sum }_{k = 1}^{3} {w}_{k} \cdot ( \frac{{f}_{{i}_{k}} \cdot {f}_{{j}_{k}}}{‖ {f}_{{i}_{k}} ‖ \cdot ‖ {f}_{{j}_{k}} ‖} ) , {\sum }_{k = 1}^{3} {w}_{k} = 1$$
where Fᵢ is a feature for the query facial image i, Fⱼ is a feature for the target facial image j, fᵢₖ is a feature of a k-th subimage of the query facial image i, and fⱼₖ is a feature of a k-th subimage of the target facial image j.

28. An apparatus for recognizing a face, the apparatus comprising:
a multi-subimage generating unit to generate multiple subimages of a query facial image and of one or more target facial images;
a feature extracting unit to extract features of the multiple subimages; and
a recognition unit to measure a similarity between features of the query facial image and the one or more target facial images using the features of the multiple subimages, calculate similarities with respect to the one or more target images, and select a facial image having a maximum similarity to the query facial image from the one or more target facial images.

29. The apparatus as claimed in claim 28, wherein the multi-subimage generating unit generates a plurality of subimages having a same size and different eye distances for a same facial image.

30. The apparatus as claimed in claim 28, wherein the similarity is defined by the Equation below;
$${F}_{i} = [ {f}_{{i}_{1}} , {f}_{{i}_{2}} , {f}_{{i}_{3}} ] , {F}_{j} = [ {f}_{{j}_{1}} , {f}_{{j}_{2}} , {f}_{{j}_{3}} ]$$
$$S ( {F}_{i} , {F}_{j} ) = {\sum }_{k = 1}^{3} {w}_{k} \cdot ( \frac{{f}_{{i}_{k}} \cdot {f}_{{j}_{k}}}{‖ {f}_{{i}_{k}} ‖ \cdot ‖ {f}_{{j}_{k}} ‖} ) , {\sum }_{k = 1}^{3} {w}_{k} = 1$$
where Fᵢ is a feature for the query facial image i, Fⱼ is a feature for the target facial image j, fᵢₖ is a feature of a k-th subimage of the query facial image i, and fⱼₖ is a feature of a k-th subimage of the target facial image j.

31. At least one medium comprising computer readable code to control at least one processing element to implement a method of recognizing a face, the method comprising:
generating multiple subimages of a query facial image and one or more target facial image;
performing Fourier transforms on the multiple subimages and extracting Fourier features from the multiple subimages using the Fourier-transformed multiple subimages;
measuring a similarity between the Fourier features of the query facial image and the one or more target facial images; and
selecting an image having a maximum similarity to the query facial image from the one or more target facial images.

32. At least one medium comprising computer readable code to control at least one processing element to implement a method of extracting a feature from a facial image, the method comprising:
performing a Fourier transform on an input image;
classifying Fourier-transformed input image into a plurality of Fourier domains;
classifying each Fourier domain into one of a plurality of frequency band that reflect corresponding features of the Fourier domain;
extracting features for each of the classified frequency bands; and
concatenating the extracted features for each Fourier domain and concatenating the concatenated, extracted features to output as features of the input image.

33. At least one medium comprising computer readable code to control at least one processing element to implement a method of recognizing a face, the method comprising:
generating multiple subimages of a query facial image and of one or more target facialimages;
extracting features of the multiple subimages;
measuring a similarity between features of the query facial image and the one or more target facial images using the features of the multiple subimages; and
selecting a facial image having a maximum similarity to the query facial image from the one or more target facial images.
